(19) United States
(12) Patent Application Publication
(10) Pub. No.: US 2005/0229781 A1
(43) Pub. Date: Oct. 20, 2005

(54) Separation method and separation apparatus of isotopes from gaseous substances

(76) Inventors: Kazuhide Hori, Tokyo (JP); Naoto Mikami, Tokyo (JP); Tadashi Kohno, Tokyo (JP); Kiyoto Inomata, Tokyo (JP)

Correspondence Address: GREENBLUM & BERNSTEIN, P.L.C., 1950 ROLAND CLARKE PLACE, RESTON, VA, 20191, US

(21) Appl. No.: 10/505,888

(22) PCT Filed: Mar. 7, 2003
(86) PCT No.: PCT/JP03/02745

§ 371 Date: Sep. 7, 2004

(30) Foreign Application Priority Data
Mar. 8, 2002 (JP) 2002-064536

(51) Int. Cl. B01D 53/02

(52) U.S. Cl. 95/90

(57) ABSTRACT

A isotopic gas of high purity is obtained at low cost, wherein for example, in a case of separating ¹³CH₄ from methane gas and obtaining ¹³CH₄ of high purity, the enrichment of ¹³CH₄, using the difference in adsorption of ¹²CH₄ and ¹³CH₄ onto an adsorbing material, is performed up to a certain concentration, and thereafter, ¹³CH₄ is enriched by a separation method by distillation that uses the difference in boiling point.

### BACKGROUND OF THE INVENTION

This invention concerns a method and a device for separating an isotopic gas, and particularly concerns an art that can be effectively applied to a method and a device for separating an isotopic gas efficiently at low energy consumption (or low electric power consumption).

As is well known, materials that exist in nature contain isotopes at certain proportions. For example, a carbon atom with a mass number of 13 (¹³C) exists as an isotope of a carbon atom with a mass number of 12 (¹²C), and for example, with methane gas that is collected as natural gas, methane gas of a mass number of 17 (¹³CH₄) exists at a proportion of 1.1 volume % in addition to methane gas of a mass number of 16 (¹²CH₄). Various industrial fields of application exist for isotopes, and for example in the medical field, carbon with a mass number of 13 (¹³C) is used. Efficient medical examination methods, etc., are for example made possible by the use of ¹³C.

Since isotopes hardly differ from each other in chemical properties, generally, it is necessary to pay a large cost for building and operating an apparatus for separating isotopes of different mass numbers from nature. For carbon isotopes, an art of separating the isotopic gas (¹³CH₄ or ¹³CO) contained in methane gas or carbon monoxide gas by distillation (low-temperature fine distillation) is known.

With a method of separating isotopes by distillation, the isotopes are separated by making use of the difference in the boiling points of the isotopes. With a distillation separation method, a device called a distillation column is used. A distillation column has a structure wherein the upper part is cooled and the lower part is heated. For example in the case of methane, when methane gas is introduced into the distillation column and the temperature distribution inside the distillation column is adjusted finely, a low-boiling-point component (¹²CH₄) collects at the upper part of the distillation column since it does not liquefy readily, and a high-boiling-point component (¹³CH₄) collects at the lower part of the distillation column since it liquefies readily. Methane gas is thus separated into ¹³CH₄ and ¹²CH₄.

However, with the above-described distillation method, there are problems due to the boiling points of the treated gases being extremely low in temperature.

As is clear from the principles, with a distillation separation method, the treatment temperature should be controlled in the vicinity of the boiling points of the treated gases. Generally, a substance that is in a gaseous state at room temperature and atmospheric pressure conditions of approximately 1 atm and 300K has an extremely low boiling point, and, for example, the boiling point of methane gas is approximately 111K. A vast amount of cooling energy is required to control a distillation column at such a cryogenic temperature. A large amount of cooling energy is consumed especially at an initial stage of distillation at which the abundance ratio of an isotope is small with respect to another isotopic gas since a large amount of gas must be controlled at a cryogenic temperature.

Also with a distillation separation method, since the isotopic gas that is to be enriched is low in recovery, a large amount of gas in the state prior to treatment (mixed gas in the sate prior to enrichment) must be introduced into the distillation column. For example, in a case where ¹³CH₄ and ¹²CH₄ are to be separated by a distillation separation method using a distillation column with practical height, if a mixed gas of ¹³CH₄ and ¹²CH₄ that contains 1.1 volume % of ¹³CH₄ is introduced into the distillation column, approximately 1 volume % of ¹³CH₄ will still be contained in the ¹²CH₄ that is discharged from upper part of the distillation column. The low recovery of the isotopic gas that is to be enriched is inevitable with the practical range of distillation column height or number of distillation columns.

Also in relation to the above-described low recovery of the isotopic gas that is to be enriched, the unavoidable increase in the proportion that equipment for the low enrichment stage occupies among the entire system for distillation separation should be noted. This means that in a case of separating an isotopic gas that is contained at a minute proportion by distillation separation, a high proportion of the energy necessary for cooling and heating is consumed at the low enrichment stage.

A distillation separation method also has the problem that a long startup time is required for attaining a concentration distribution necessary for steady-state operation from the start of supply of treated gas and energy into the distillation column (time in year units may be required depending on the scale of the plant). This is also a factor that increases operation costs.

As an art besides methods using distillation, there is the art proposed in Japanese unexamined Patent Publication No. Hei 10-128071. With this art, zeolite, having a pore diameter close to the molecular diameter of the isotopic gas, is used and the differences in adsorption onto zeolite of the isotopic gases that differ in mass number are used to separate the isotopic gases. Also, Japanese unexamined Patent Publication No. 2001-219035 discloses an art of using a zeolite-based adsorbing material to separate ¹²CO and ¹³CO. This art uses the zeolite-based adsorbing material property of selectively adsorbing ¹³CO more readily in order to separate ¹²CO and ¹³CO.

With the above-described separation of isotopic gases using adsorption, a vast amount of cooling energy is not required as in the case of distillation separation. However, with this method of separating isotopic gases using adsorption, the enrichment efficiency at the final stage of enrichment is not necessarily good. This becomes a problem in a case where an isotopic gas of high purity is to be obtained.

### SUMMARY OF THE INVENTION

An object of the present invention is to provide an art for separating isotopic gases that does not require a vast amount of input energy and enables the shortening of the startup period. Another object of this invention is to provide an art for separating an isotopic gas that exists in minute amounts and enriching the isotopic gas to high purity efficiently and at low cost.

First, the terms used in this Description shall be described. “Isotopic gas of low mass number” refers to an isotopic gas having an atom of smaller mass number as its component. “Isotopic gas of high mass number” refers to an isotopic gas having an atom of higher mass number as its component. For example in the case of methane gas, ¹²CH₄ is the isotopic gas of low mass number and ¹³CH₄ is the isotopic gas of high mass number.

“Molecular gas” refers to a gas, such as methane, with which the components are molecules. “Atomic gas” refers to a gas, such as argon, with which the components are atoms. “Mixed gas” refers to a gas to be treated that contains a plurality of types of isotopic gases. A mixed gas may contain other impurities. Examples of mixed gases that can be used include methane gas, which is separated from natural gas and contains ¹²CH₄ and ¹³CH₄ at a volume ratio of 0.99:0.01, and carbon monoxide gas, containing ¹²CO and ¹³CO at a volume ratio of 0.99:0.01.

“First gas” refers to the isotopic gas of low mass number and the isotopic gas of the first gas that is to be separated is the isotopic gas of high mass number. Though generally the term, “isotope,” is used in a manner such that atoms or molecules consisting of the same elements that differ in mass numbers are mutually called isotopes, with the term, “isotope,” in the description of this invention, the gas of high mass number that is to be separated is referred to as the “isotopic gas.” Though the abovementioned first gas and the isotopic gas in the abovementioned expression are isotopes of each other and, broadly speaking, it is thus possible to refer to the first gas as an isotopic gas as well, with the present Description, the isotopic gas of low mass number is referred to by the term, “first gas,” and the isotopic gas of high mass number is referred to by the term, “isotopic gas.”

For separation and enrichment of an isotopic gas, this invention makes use of a method using adsorption in a low enrichment stage and thereafter makes use of a method that uses distillation to enrich the isotopic gas further. According to findings obtained by the present inventors, although a method using adsorption is comparatively low in consumption energy, it is unsuited for enrichment of an isotopic gas at a stage at which the concentration has become high. On the other hand, with a method using distillation, the scale will not become very large and the consumption energy will not be much of a problem if concentration has progressed to some degree. Moreover, in comparison to a method using adsorption, a method using distillation is more suited to the enrichment of an isotopic gas at a stage at which the concentration has become high. The two methods are thus combined to perform separation and enrichment of an isotopic gas using adsorption at a low enrichment stage and then switching to separation and enrichment of the isotopic gas by distillation at a stage at which enrichment has progressed to some degree. The overall consumption energy can thus be reduced in comparison to the prior arts and yet an isotopic gas of high concentration (isotopic gas of high purity) can be obtained readily.

This invention makes use of either of two phenomena for separating an isotopic gas by adsorption. One is the phenomenon that when a mixed gas containing two or more types of isotopic gases is made to contact an adsorbing material that meets specific conditions, it is more difficult for the isotopic gas to become adsorbed and become desorbed in comparison to the first gas.

By making use of this phenomenon and making a mixed gas containing two or more types of isotopic gases contact an adsorbing material that meets specific conditions, the concentration of the isotopic gas can be made high at the beginning of recovery of the contacted gas. For example, when the abovementioned mixed gas is made to flow when the adsorbing material that meets specific conditions is in a state in which the isotopic gas that is to be separated is not adsorbed, the molecules of the first gas become captured first and then the molecules of the isotopic gas become captured at a delayed timing. Thus with the mixed gas at the initial stage at which its flow is started, the proportion of the isotopic gas will be relatively greater than the proportion of the first gas. A mixed gas, with which the isotopic gas is separated and enriched, can thus be obtained.

Also by making use of the above-described phenomenon and performing desorption with the adsorbing material that meets the specific conditions being in a state where two or more types of isotopic gases are adsorbed and recovering the desorbed gas after the elapse of a predetermined time from the start of desorption, a gas, with which the proportion of the isotopic gas, which is delayed in desorption, has been made high, can be obtained. With the present Description, “desorption” refers to the separation of an adsorbed substance from a surface to which the substance is adsorbed.

The other phenomenon that this invention makes use of is the phenomenon that when a mixed gas containing two or more types of isotopic gases is made to contact an adsorbing material that meets specific conditions, the isotopic gas becomes adsorbed more readily than the first gas.

By making use of this phenomenon and contacting a mixed gas with a specific adsorbing material and causing the adsorbed gas components to desorb thereafter, the proportion of the isotopic gas among the desorbed components becomes higher than that prior to adsorption. Separation and enrichment of the isotopic gas can thus be performed using this phenomenon.

In outline, this invention provides the following. A first mode of this invention provides in an isotopic gas separation method for separating, from a mixed gas containing a molecular or atomic first gas, an isotopic gas of the abovementioned first gas, an isotopic gas separation method comprising: one of either a first treatment procedure, in turn comprising the steps of: supplying the abovementioned mixed gas to a gas inlet of an adsorption chamber; and taking out the isotopic gas of the abovementioned first gas that flows out from a gas outlet of the abovementioned adsorption chamber from the start of supplying of the abovementioned mixed gas to the point of elapse of a predetermined time; or a second treatment procedure, in turn comprising: a first step of sealing the abovementioned mixed gas in an adsorption chamber; a second step of making the abovementioned mixed gas flow out from the abovementioned adsorption chamber after the abovementioned first step; and a third step of taking out the isotopic gas of the abovementioned first gas after the elapse of a predetermined time from the start of the abovementioned second step; and further comprising: a treatment procedure of enriching, by distillation, the abovementioned isotopic gas of the abovementioned first gas that has been taken out.

With the above-described first mode of this invention, the gas that flows out from the interior of the adsorption chamber takes out, at a stage at which the adsorption and desorption onto the adsorbing material of the first gas is closer to the equilibrium state, but the adsorption and desorption of the isotopic gas does not become the equilibrium state yet. Therefore, a mixed gas with which the concentration of the isotopic gas has been increased is obtained. Then at a stage at which the concentration of the isotopic gas has become high to some degree, further separation of the isotopic gas and the first gas is performed by distillation. In a region in which the concentration of the isotopic gas is low, the separation of isotopic gas by use of adsorption is comparatively high in efficiency and is energy-saving in comparison to distillation. The problem of large consumption energy at the low enrichment stage in the prior-art method by distillation is thus resolved. Also, since in a region in which the concentrated concentration has become high, distillation, which is better in separation efficiency (enrichment efficiency) in comparison to a method using adsorption, is used, an advantage is provided in terms of obtaining isotopic gas of high purity.

Also with the above-described first mode of this invention, by recovering gas, which flows out of the adsorption chamber from a state of being sealed inside the adsorption chamber, after the elapse of a predetermined time from the start of outflow, gas, which has been made high in the concentration of the isotopic gas that is delayed in desorption, can be recovered. The same effects as those described above can also be obtained in this case by switching to distillation at a stage at which the concentration of the isotopic gas has become high to some degree.

The switching from separation using adsorption to separation by distillation is performed at a stage at which the concentration, in the recovered gas, of the isotopic gas that is to be separated exceeds the natural abundance ratio and preferably at a stage at which the concentration of the isotopic gas has become 10 to 80 volume % and more preferably at a stage at which the concentration of the isotopic gas has become 10 to 50 volume %. When the concentration of the isotopic gas to be separated is less than 10 volume %, separation using distillation will be relatively high in cost. However, in a case where an adsorption separation equipment is to be added to an existing distillation equipment in order to answer demands for increased production, etc., the cost can be made lower than in a case where a distillation equipment is to be installed additionally even if the concentration at which the abovementioned switch is made is less than 10 volume %. When the concentration of the isotopic gas that is to be separated exceeds 50 volume %, the method of separation using adsorption becomes low in separation efficiency and the merit thereof falls.

As the material for adsorbing the isotopic gas in the above-described first mode of this invention, activated carbon, A-type zeolite, or a complex may be used. Examples of a complex that can be used include a three-dimensional metal complex of dicarboxylic acid, etc. As the mixed gas, methane gas or ammonia gas may be used.

With the above-described first mode of this invention, after performing separation of the isotopic gas, it is preferable to perform a regeneration process of heating the adsorbing material under a reduced-pressure atmosphere and removing the adsorbed substances and then perform the isotopic gas separation process again in a repeating manner.

As the adsorption of the isotopic gas progresses, saturation occurs and a state of equilibrium is reached as adsorption and desorption become nearly equivalent. When this occurs, the proportion of the isotopic gas in the mixed gas will be the same before and after contact with the adsorbing material and the separation efficiency of the isotopic gas that is to be separated drops. Thus after performing adsorption of the isotopic gas to be separated, by removing the substances that had become adsorbed onto the adsorbing material and recovering the adsorbing ability of the adsorbing material, the separation of the isotopic gas can be performed again. By thus performing the isotopic gas separation process and the adsorbing material regeneration process repeatedly, efficient separation of the isotopic gas can be performed.

A second mode of this invention provides in an isotopic gas separation method for separating, from a mixed gas containing a molecular or atomic first gas, an isotopic gas of the abovementioned first gas, an isotopic gas separation method comprising the steps of supplying the abovementioned mixed gas to a gas inlet of an adsorption chamber; stopping the abovementioned supply after the elapse of a predetermined time from the start of supply of the abovementioned mixed gas; depressurizing the interior of the abovementioned adsorption chamber in a relative manner and taking out the abovementioned mixed gas that had become adsorbed inside the abovementioned adsorption chamber; and enriching, by distillation, the isotopic gas of the abovementioned first gas contained in the abovementioned mixed gas that has been taken out.

A third mode of this invention provides in an isotopic gas separation method for separating, from a mixed gas containing a molecular or atomic first gas, an isotopic gas of the abovementioned first gas, an isotopic gas separation method comprising the steps of supplying the abovementioned mixed gas to a gas inlet of an adsorption chamber; stopping the abovementioned supply after the elapse of a predetermined time from the start of supply of the abovementioned mixed gas; making carrier gas flow inside the abovementioned adsorption chamber and taking out, along with the abovementioned carrier gas, the abovementioned mixed gas that had become adsorbed inside the abovementioned adsorption chamber; and enriching, by distillation, the isotopic gas of the abovementioned first gas contained in the abovementioned mixed gas that has been taken out.

With the above-described second and third modes of this invention, more of the isotopic gas, which becomes adsorbed readily onto the adsorbing material in the adsorption chamber, becomes adsorbed in the adsorption chamber, and by recovering the adsorbed component, the isotopic gas that has become relatively higher in concentration can be obtained. Separation and enrichment of the isotopic gas can thereby be performed. Furthermore, by performing the abovementioned enrichment using adsorption at an early stage of enrichment at which the concentration of the isotopic gas is low and switching to enrichment using distillation from a stage at which the enrichment has progressed, low energy consumption (for example, low power consumption) and high purity at high efficiency can be realized.

With the above-described second and third modes of this invention, a porous material may be used as the material for adsorbing the isotopic gas. In particular, zeolite, activated carbon, silica gel, or alumina may be used as the material for adsorbing the isotopic gas. Also, carbon monoxide gas may be selected as the mixed gas. In a case where copper-ion-exchanged zeolite is used as the adsorbing material, ammonia gas may be selected as the mixed gas. In this case, ¹⁴NH₃ and ¹⁵NH₃ are separated and enrichment of ¹⁵NH₃ can be performed.

With the second and third modes of this invention, the switching from separation using adsorption to separation using distillation is also performed at a stage at which the concentration, in the recovered gas, of the isotopic gas that is to be separated exceeds the natural abundance ratio and preferably at a stage at which the concentration becomes 10 to 80 volume % and more preferably at a stage at which the concentration becomes 10 to 50 volume %.

Also with the above-described second and third modes of this invention, faujasite, pentasil zeolite, mordenite, or A-type zeolite is preferably used as zeolite.

This invention can also be put to practice in the form of an isotopic gas separation device. In this case, the device has an arrangement or means for executing this invention's isotopic gas separation method described above.

As has been described above, with the present invention, since enrichment at a low enrichment stage is performed by an adsorption method and enrichment using distillation is performed at a stage of transition into a stage of relatively high enrichment, the load placed on distillation equipment at the low enrichment stage can be lightened. The number of distillation columns of a plant as a whole can thus be reduced in comparison to a case where only distillation processes are carried out. Or, the effect of reducing the number of enrichment stages or lowering the height of a distillation column can be provided. In this case, since the absolute amount of holdup liquid (a flow with which the first gas in the liquefied condition is the main component) that is refluxed within the distillation column can be reduced, the startup period until the attainment of the concentration distribution for steady-state operation can be reduced. The operation cost can thus be reduced in comparison to the case where only a distillation process is used.

The above-described invention may be used to achieve low cost by combining an adsorption process with a part of a distillation process that is already in operation. Examples of modes of practice include providing, in a plant for isotope separation by distillation with which increased production of isotopic gas is demanded, an additional adsorption separation equipment at a part at which an enrichment process of a low enrichment stage is performed and making a part of the isotopic gas enrichment process be shouldered by an adsorption process or making a part of the treatment be shouldered by the adsorption process in a parallel manner to increase the productivity of the low enrichment stage process. The advantage of alleviating the load placed on a distillation process of a low enrichment stage can be obtained with such a method as well.

As an isotope separation process (isotope enrichment process) using adsorption, any of the above-described arts of isotope separation by adsorption may be selected as suited according to the gas or adsorbing material.

Though the effects of this invention can be provided most highly by putting the isotope separation process (isotope enrichment process) using adsorption to use at an early stage of an isotope separation process, the use is not limited necessarily to an early stage of an isotope separation process as long as the economy of a distillation process in a stage of relatively low enrichment can be improved.

By above mentioned invention, an isotopic gas separation art that does not require a vast amount of input energy and enables shortening of the startup period is provided. This invention also provides an art for performing efficient and low-cost separation of an isotopic gas, which exists in minute amounts, and enrichment of the isotopic gas to high purity.

### BRIEF DESCRIPTION OF THE DRAWINGS

FIG. 1 is a diagram, showing an example of a system for carrying out this invention's isotopic gas separation method.

FIG. 2 is a flowchart, showing an example of a treatment procedure of an embodiment to which this invention's isotopic gas separation method is applied.

FIG. 3 is a flowchart, showing an example of a treatment procedure of an embodiment to which this invention's isotopic gas separation method is applied.

FIG. 4 is a diagram, showing an example of a system for carrying out this invention's isotopic gas separation method.

FIG. 5 is a flowchart, showing an example of a treatment procedure of an embodiment to which this invention's isotopic gas separation method is applied.

### DETAILED DESCRIPTION OF THE INVENTION

Embodiments of this invention shall now be described in detail based on drawings. However, this invention may be practiced in various different modes and should not be interpreted as being limited to these descriptions of the embodiments. Throughout all of the embodiments, the same elements shall be provided with the same numbers.

### First Embodiment

An example of an isotopic gas separation method arranged on the basis of the findings given above shall now be described. The isotopic gas separation method using adsorption in this embodiment makes use of the phenomenon in which a specific isotopic gas is less readily adsorbed onto and desorbed from a specific adsorbing material in comparison to a first gas. The separation of isotopic gas using adsorption in this embodiment makes use of the phenomenon that in the process of passing a mixed gas through an adsorption chamber in which is installed the adsorbing material, the gas that is passed through in an early stage contains the isotopic gas at high concentration since the isotopic gas is less readily adsorbed in comparison to the first gas.

With the present embodiment, ¹²CH₄ is used as the first gas, ¹³CH₄ is used as the isotopic gas to be separated, and activated carbon is used as the adsorbing material.

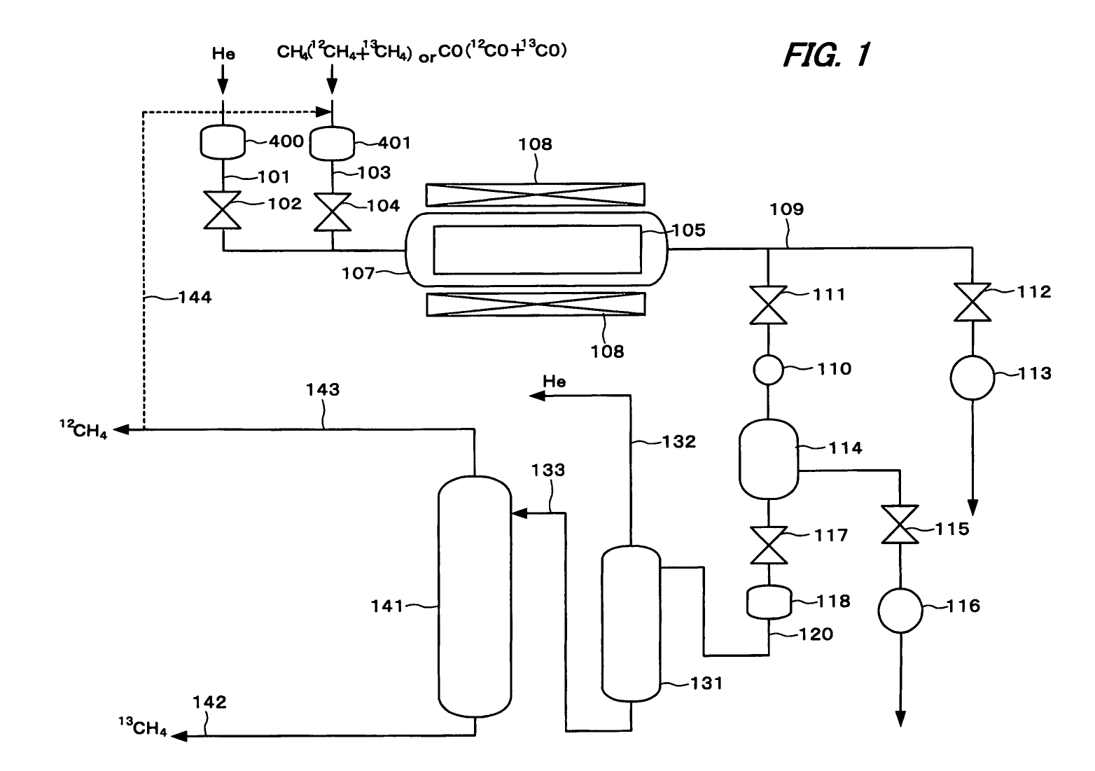

FIG. 1 is a diagram, showing an example of a system for carrying out this invention's isotopic gas separation method. The system shown in FIG. 1 comprises a flow regulating device 400, flow regulating device 401, piping 101, valve 102, piping 103, valve 104, activated carbon 105, adsorption chamber 107, temperature regulating device 108, piping 109, recovery pump 110, valve 111, valve 112, exhaust pump 113, recovery tank 114, valve 115, exhaust pump 116, valve 117, flow regulating device 118, piping 120, distillation column 131, piping 132, piping 133, distillation column 141, piping 142, and piping 143.

Helium (He) gas, to be used as carrier gas, is introduced from piping 101. High-purity methane (CH₄) gas is introduced from piping 103. Needless to say, high-purity methane contains both ¹²CH₄ and ¹³CH₄. Adsorption chamber 107 has a structure enabling the interior to be maintained at a reduced pressure state. Adsorption chamber 107 can be heated or cooled to a predetermined temperature by means of temperature regulating device 108 and the internal temperature can be adjusted arbitrarily. The interior of adsorption chamber 107 can be put in a reduced pressure state by means of recovery pump 110 and exhaust pump 113.

Activated carbon 105 functions as an adsorbing material. As activated carbon 105, activated carbon having an average pore diameter of 2 times and preferably as close to 1 time the molecular diameter of methane is used. This is because it has been confirmed experimentally that when the average pore diameter of activated carbon is 2 times and preferably as close to 1 time the molecular diameter of methane, ¹²CH₄ and ¹³CH₄ can be separated efficiently.

An example of a method of producing activated carbon shall now be described. As a raw material for activated carbon, a material selected from among cellulose, cellulose compounds, polyimide, polyimide compounds, and natural substances and artificial substances having cellulose as the main component or a mixture of a plurality of such materials may be used. For production, first the raw material is made into a powder and placed in a mold upon addition of a binder as necessary. This is then pressurized to obtain material of a predetermined shape. Thereafter, the molded material is subject to heat treatment. The heat treatment is performed in two steps. First, heat treatment for carbonization is performed. This heat treatment is performed for example under a nitrogen atmosphere and under the condition of 1073K for 6 hours. The material is carbonized by this heat treatment. A second heat treatment is then performed. This heat treatment is performed for example under a carbon dioxide atmosphere and under the condition of 1173K for 6 hours. Activation occurs and a change to a porous state progresses in this second heat treatment. Though the change to the porous state also occurs in the first heat treatment, the change to the porous state proceeds further in the second heat treatment. By controlling the conditions of the second heat treatment, the density of pores and the pore diameter can be controlled. Since the control conditions for the pore diameter and density of pores depend on the raw material and the atmosphere, these must determined by experiment.

Recovery tank 114 is a tank for recovering gas exhausted from adsorption chamber 107. Distillation column 131 is a distillation column for separating methane from helium, which is the carrier gas, by distillation. Distillation column 131 may be a gas separation device, such as a PSA. The separation of ¹²CH₄ and ¹³CH₄ is carried out at distillation column 141. Distillation column 141 is equipped with unillustrated temperature regulating devices at its upper part and lower part and has a function of collecting a high-boiling-point component at the lower part of the distillation column, collecting a low-boiling-point component at the upper part of the distillation column, and thereby separating the high-boiling-point component from the low-boiling-point component. PSA is the abbreviation for Pressure Swing Adsorption.

In the following, an example of a process for separating and extracting ¹³CH₄ from high-purity methane gas shall be described. In the following ¹²CH₄ corresponds to being the first gas of this invention and ¹³CH₄ corresponds to being the isotopic gas of the first gas of this invention.

The high-purity methane gas corresponds to being the mixed gas containing the first gas and the isotopic gas of this invention.

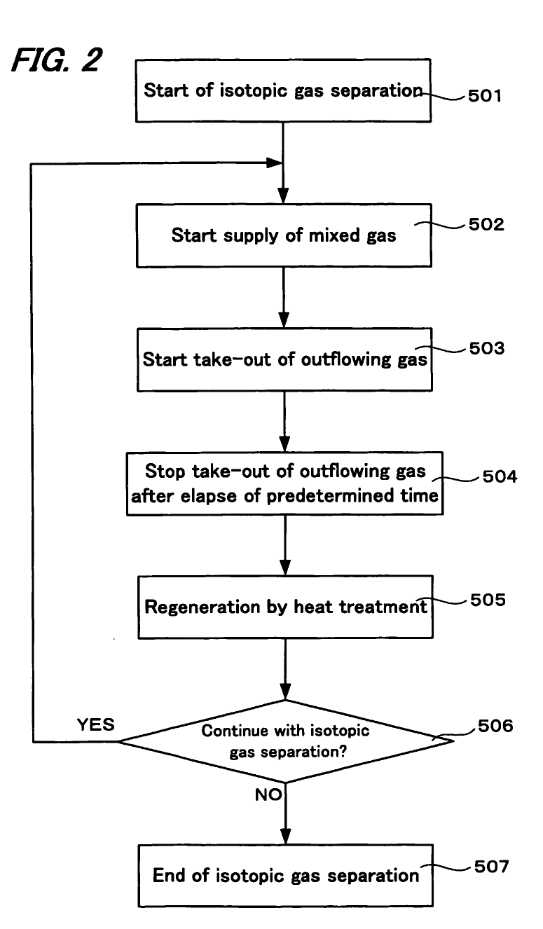

FIG. 2 is a flowchart, showing an example of a treatment procedure of an embodiment to which this invention's isotopic gas separation method is applied.

First, in a state where all valves are closed, exhaust pump 113 is made to operate, valve 112 is opened, and adsorption chamber 107 is put in a state of reduced pressure. Valve 112 is then closed and valve 102 is then opened to fill the interior of adsorption chamber 107 with helium gas. Valve 102 is then closed and valve 112 is opened with exhaust pump 113 being in operation to exhaust the helium gas inside adsorption chamber 107. This series of operations is repeated a plurality of times to remove impurities that exist in adsorption chamber 107 as much as possible and regenerate activated carbon 105 at the same time. Adsorption chamber 107 is then put in a high vacuum state of 13 Pa or less. Also, valves 111 and 117 are closed and then valve 115 is opened with exhaust pump 116 being in operation to bring the interior of recovery tank 114 to a high vacuum state. When the interior of recovery tank 114 has been brought to a high vacuum state, valve 115 is closed.

Separation of the isotopic gas is carried out from this state. Here, the separation of ¹³CH₄, which is the isotopic gas of ¹²CH₄, is started (step 501). First, with valves 111 and 112 being closed, valve 102 and valve 104 are opened and then valve 111 is opened to introduce high-purity methane gas and helium gas into adsorption chamber 107 (step 502). In this process, flow regulating devices 400 and 401 are adjusted to realize flow at a predetermined flow rate, and the opening of valve 111 is adjusted to maintain the pressure inside adsorption chamber 107 at a predetermined pressure. Also, temperature regulating device 108 is made to operate to maintain the temperature inside adsorption chamber 107 at a fixed value (for example, 278K). Flow regulating devices 400 and 401 are adjusted so that the ratio of the flow rates of methane gas and helium gas will for example be 1:9.

The methane gas and helium gas that flow into adsorption chamber 107 flow through the interior of adsorption chamber 107 and is recovered in recovery tank 114 by means of recovery pump 110 (step 503). With the flow of methane gas that flows into adsorption chamber 107, since ¹²CH₄ is more readily adsorbed by activated carbon 105 in comparison to the isotopic gas, ¹³CH₄, ¹²CH₄ begins to be adsorbed by the activated carbon first and ¹³CH₄ begins to be adsorbed by activated carbon 105 at a delayed timing. As a result, with the gas that is discharged from adsorption chamber 107 to recovery tank 114, the concentration of ¹³CH₄ is higher in comparison to that of ¹²CH₄ at the initial stage. As the methane gas is made to flow for some period of time, the adsorption amount and desorption amount of ¹³CH₄ reach an equilibrium and the ratio of ¹²CH₄ to ¹³CH₄ in the methane gas that is discharged from adsorption chamber 107 becomes substantially equal to the ratio of ¹²CH₄ to ¹³CH₄ in the methane gas that flows into adsorption chamber 107.

Thus at a stage at which a predetermined time has elapsed, valve 111 is closed and the take-out of flowing gas from adsorption chamber 107 is stopped (step 504). This time from the start of inflow to the stoppage of inflow of the methane gas into adsorption chamber 107 is set, for example, to 200 seconds. The methane gas that is discharged from adsorption chamber 107 during this period is high in the concentration of ¹³CH₄. Exhaust gas (methane gas and helium gas), with which the ¹³CH₄ concentration has been increased, is thus collected in recovery tank 114. The exhaust gas that has been collected in recovery tank 114 is sent from recovery tank 114 to distillation column 131 as suited by the function of flow regulating device 118. The separation of methane gas and helium gas is performed at distillation column 131. The methane gas is then sent to distillation column 141 via piping 133. The helium gas is recovered from piping 132.

After stoppage of inflow of the methane gas into adsorption chamber 107, valve 112 is opened with exhaust pump 113 being in operation to bring the interior of adsorption chamber 107 to a high vacuum state. In this process, temperature regulating device 108 may be controlled to heat the interior of adsorption chamber 107 to enhance the desorption efficiency. The heating temperature is set, for example, to 373K. Valve 102 is then opened to make helium gas flow into adsorption chamber 107. The regeneration process of desorbing the ¹²CH₄ molecules and ¹³CH₄ molecules that had become adsorbed onto activated carbon 105 is thus executed (step 505).

After the regeneration process, the judgment of repeating the process of separating ¹³CH₄ again is made (step 506), and the methane gas is introduced inside adsorption chamber 107 again and the ¹³CH₄ separation process of the next cycle is performed. The ¹³CH₄ separation process using activated carbon 105 and the regeneration process of activated carbon 105 are thus performed repeatedly. In conjunction with these processes, methane gas, which has been made high in ¹³CH₄ concentration, and helium gas, which is the carrier gas, are collected in recovery tank 114, and the collected gas is sent to distillation column 131 from recovery tank 114. The separation of helium gas and methane gas is then performed at distillation column 131. The separated methane gas is then sent to distillation column 141 from piping 133. If the ¹³CH₄ separation process is to be ended, a “no” judgment is made at step 506 and the separation of the isotopic gas is ended (step 507). The respective steps described above may be executed automatically in accordance with a priorly prepared program using an unillustrated computer control device, etc.

Normally, steps 502 to 506 of FIG. 2 are repeated. Helium gas and methane gas, which has been made high in ¹³CH₄ concentration, are then sent continuously via piping 120 to distillation column 131, at which the helium gas is separated. In the adsorption process, the methane gas that has been made high in ¹³CH₄ concentration is then sent from distillation column 131 to distillation column 141.

In a stage prior to the distillation process, the concentration of ¹³CH₄ in the methane gas is preferably 10 volume % or more. This is for avoiding the consumption of vast amounts of energy and the making of the equipment large in scale for the initial stage at the start of separation (start of enrichment) by the method of isotope separation by distillation. Based on the findings of the present inventors, a significant reduction in cost in comparison to the prior-art process of separation and enrichment by distillation alone can be achieved if the concentration of ¹³CH₄ existing in the methane gas is 10 volume % or more. The methane gas that has been sent to distillation column 141 is subject further to the separation of ¹²CH₄ and ¹³CH₄ there. At distillation column 141, the temperature of the interior is adjusted to a value near the boiling point of methane to set up a state under which both ¹²CH₄ and ¹³CH₄ will liquefy readily. When under this state, the lower part of distillation column 141 is heated slightly and the upper part is cooled slightly, a state, in which ¹²CH₄, which is a low-boiling-point component in comparison to ¹³CH₄, gasifies more readily due to the boiling point difference, is obtained under delicate conditions. That is, by fine adjustment of an unillustrated temperature regulating device equipped in distillation column 141, a 0.03K difference in boiling point is used to set up a state in which the low-boiling-point component gasifies readily and the high-boiling-point component does not gasify readily but liquefies readily. As a result, the low-boiling-point component (¹²CH₄) collects at the upper part of distillation column 141 and is discharged to the exterior from piping 143. Meanwhile, the high-boiling-point component (¹³CH₄) collects at the lower part of distillation column 141 and is taken out via piping 142. With case of using the distillation column of practical height, it is impossible to separate ¹²CH₄ and ¹³CH₄ completely and a considerable amount of ¹³CH₄ will be contained in the methane gas that is discharged from piping 143.

The methane gas that is discharged from piping 143 may then be guided to piping 144 and mixed with the raw material methane gas and thereby subject to recycled use to improve the efficiency further. Also, though the exhaust gas from adsorption chamber 107 was collected in recovery tank 114 once in the above description, the exhaust gas may be guided intermittently to distillation column 131 directly without the use of recovery tank 114.

Though distillation column 141 is indicated as a distillation column for performing the separation of ¹²CH₄ and ¹³CH₄ in FIG. 1, in practice, distillation columns may be disposed in more stages to perform distillation through a greater number of stages in accordance with the targeted purity of ¹³CH₄. Also, the separation (enrichment) of ¹³CH₄ by distillation is high in controllability. ¹³CH₄ of the desired purity can thus be obtained readily.

With the above-described ¹³CH₄ separation method (enrichment method), since the consumption of energy (for example, electric power) at the low concentration stage can be restrained, the entire system can be made low in consumption energy (for example, power-saving) and can thus be made high in economy. The treatment speed is also high.

Especially with the method of the present embodiment, the enrichment of ¹³CH₄, which theoretically uses only the distillation column which requires several thousand stages, can be simplified. In particular, since a distillation process, which consumes a large amount of energy (for example, electric power), is not used at a low concentration stage of the separation process in which a large amount of methane gas must be processed, the running cost for obtaining ¹³CH₄ of high purity can be reduced greatly in comparison to the prior art of using only distillation. The equipment cost can also be reduced since the equipment can be simplified.

The enrichment of isotopic gas by adsorption may also be carried out in a plurality of stages in order to obtain the necessary concentration.

Though with the present embodiment, activated carbon was used as an example of an adsorbing material, a porous complex, zeolite, or other porous material, which is suitably adjusted in pore diameter or which has suitable pore diameter, may be used instead. A three-dimensional metal complex of a dicarboxylic acid, etc., may be given as an example of a porous complex.

### Second Embodiment

With this embodiment, an isotopic gas is separated and enriched by sealing a mixed gas once inside an adsorption chamber in which an adsorbing material is stored and thereafter taking out the mixed gas that flows from the adsorption chamber after the elapse of a predetermined time from the start of outflow of the mixed gas. As with the first embodiment, this embodiment also uses the phenomenon that in comparison to a first gas, a specific isotopic gas is less readily adsorbed onto a specific adsorbing material and is less readily desorbed from that adsorbing material.

With this embodiment, ¹²CH₄ is used as the first gas, ¹³CH₄ is used as the isotopic gas to be separated, and activated carbon is used as the adsorbing material.

This embodiment uses the system shown as an example in FIG. 1. Here, a case of separating ¹³CH₄, which is the isotopic gas of ¹²CH₄, from high-purity methane gas shall be described. Also, with this embodiment, an example of use of the same activated carbon as that of the first embodiment as the adsorbing material shall be described.

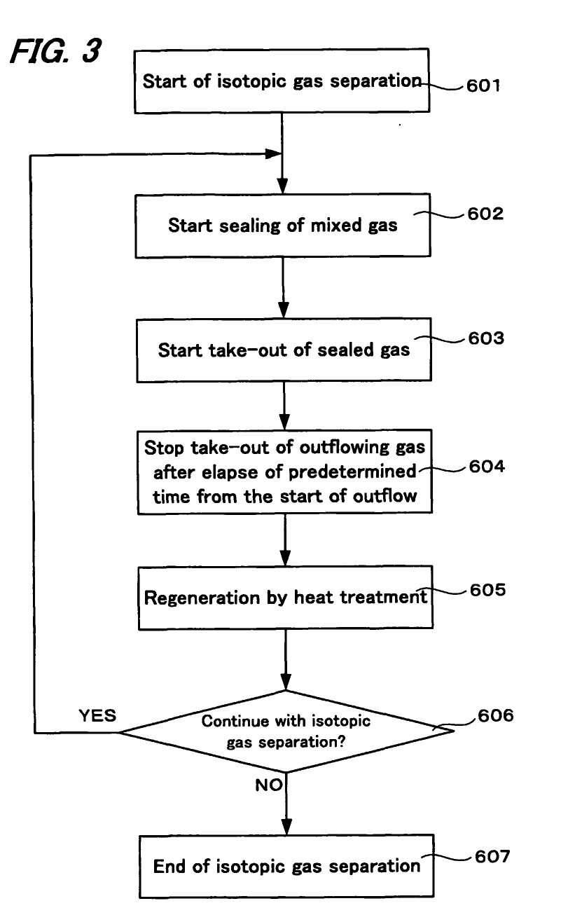

FIG. 3 is a flowchart showing an example of a treatment procedure of an embodiment to which this invention's isotopic gas separation method is applied.

First, in a state where all valves are closed, valve 112 is opened, exhaust pump 113 is made to operate, and adsorption chamber 107 is put in a state of reduced pressure. Valve 112 is then closed and valve 102 is then opened to fill the interior of adsorption chamber 107 with helium gas. Valve 102 is then closed and valve 112 is opened with exhaust pump 113 being in operation to exhaust the helium gas inside adsorption chamber 107. This series of operations is repeated a plurality of times to remove impurities that exist in adsorption chamber 107 as much as possible and regenerate activated carbon 105 at the same time. Adsorption chamber 107 is then put in a high vacuum state of 13 Pa or less. Recovery tank 114 is also put in a high vacuum state.

From this state, the separation of the isotopic gas, in this case, the separation of ¹³CH₄, which is the isotopic gas of ¹²CH₄, is started (step 601). First, with valve 112 being closed, valve 102 and valve 104 are opened to introduce helium gas from piping 101 and high-purity methane gas from piping 103 into adsorption chamber 107. In this process, flow regulating devices 400 and 401 are adjusted to make the helium gas and high-purity methane gas flow into adsorption chamber 107 until the interior of adsorption chamber 107 reaches a predetermined pressure. The flow rates of the methane gas and helium gas are set for example to a ratio of 1:9. When the interior of adsorption chamber 107 is filled with the helium and high-purity methane gas and the predetermined internal pressure is attained, valves 102 and 104 are closed to obtain a state in which the helium and high-purity methane gas are sealed inside adsorption chamber 107 (step 602). In this process, temperature regulating device 108 is made to operate to maintain the temperature inside adsorption chamber 107 at a fixed value (for example, 278K).

The time for which the high-purity methane gas is kept sealed inside adsorption chamber 107 is not less than a time with which ¹³CH₄ will become adequately adsorbed onto activated carbon 105. The time for which the high-purity methane gas is kept sealed inside adsorption chamber 107 is set for example to 500 seconds.

After sealing the high-purity methane gas inside adsorption chamber 107 for the predetermined time, valve 112 is opened and the gas that was sealed inside adsorption chamber 107 is exhausted out of the system (step 603). Then after the elapse of a predetermined time from the start of outflow of gas, valve 112 is closed and valve 111 is opened. The high-purity methane gas that was sealed inside adsorption chamber 107 is thus taken out at a certain point in time and recovered in recovery tank 114 (step 604). Here, the predetermined time from the start of outflow is set, for example, to 50 seconds.

When the taking out of the high-purity methane gas from adsorption chamber 107 into recovery tank 114 is ended, valve 111 is closed.

In the state in which the high-purity methane gas is sealed inside adsorption chamber 107, ¹³CH₄ and ¹²CH₄ become adsorbed onto activated carbon 105. Then when the high-purity methane gas that was sealed inside adsorption chamber 107 is taken out, first ¹²CH₄ begins to desorb from activated carbon 105 and ¹³CH₄ begins to desorb from activated carbon 105 at a delayed timing. Thus if outflowing gas is recovered after the elapse of a predetermined time from the start of outflow of the high-purity methane gas from adsorption chamber 107, the abundance ratio of ¹³CH₄, which is delayed in desorption, in the outflowing gas will be higher than that of ¹²CH₄, which had become desorbed earlier. High-purity methane gas, which is enriched in ¹³CH₄ is thus collected in recovery tank 114.

The high-purity methane gas collected in recovery tank 114 is sent as suited to distillation column 131 by the function of flow regulating device 118 and the helium gas is separated there. The high-purity methane gas that has been separated from the helium gas is guided via piping 133 from distillation column 131 to distillation column 141 and is subject to further enrichment of ¹³CH₄. As with the first embodiment, 131 may be a gas separation device, such as a PSA. Since the process at distillation column 141 is the same as that of the first embodiment, a description thereof shall be omitted.

Next, with exhaust pump 113 being in operation, valve 112 is opened and the interior of adsorption chamber 107 is put in a high vacuum state.

In this process, temperature regulating device 108 may be controlled to heat the interior of adsorption chamber 107 to enhance the regeneration efficiency. The heating temperature is set, for example, to 373K. Valve 102 is then opened to make helium gas flow and the ¹²CH₄ and ¹³CH₄ that had become desorbed from activated carbon 105 are discharged from adsorption chamber 107. The regeneration process is thus executed (step 605).

Normally after the regeneration process, the judgment of repeating the process of separating ¹³CH₄ again is made (step 606), and the methane gas is introduced inside adsorption chamber 107 again and the ¹³CH₄ separation process of the next cycle is performed. The ¹³CH₄ separation process using activated carbon 105 and the regeneration process of activated carbon 105 are thus performed repeatedly to send methane gas, which has been made high in ¹³CH₄ concentration, to distillation column 131.

A process of not using recovery tank 114 may also be carried out in the present embodiment as well.

The concentration of ¹³CH₄ at the stage of introduction into distillation column 141 is set to 10 volume % or more in the present embodiment as well.

To end the ¹³CH₄ separation process, a “no” judgment is made in step 606 and the separation of the isotopic gas using adsorption is ended (step 607). Also, the respective steps described above may be executed automatically in accordance with a priorly prepared program using an unillustrated computer control device, etc.

The same advantage of enabling separation of ¹³CH₄ at low cost, provided by the first embodiment, is also provided by the present embodiment.

With the present embodiment, the piping that is used to make methane gas flow into adsorption chamber 107, which is the adsorption chamber, and the piping that is used to discharge methane gas from adsorption chamber 107 may be the same piping.

Though with the above-described embodiment, activated carbon was used as an example of an adsorbing material, a porous complex, zeolite, or other porous material, which is suitably adjusted in pore diameter or which has suitable pore diameter, may be used instead. A three-dimensional metal complex of a dicarboxylic acid, etc., may be given as an example of a porous complex.

### Third Embodiment

This embodiment is an example of use of the phenomenon that, with a specific adsorbing material and a specific mixed gas, the adsorption onto the adsorbing material occurs relatively more readily with the isotopic gas than the first gas. That is, a mixed gas of the first gas and the isotopic gas is made to flow in and pass through an adsorption chamber, the inflow and outflow of the mixed gas into and from the adsorption chamber is stopped at a stage at which a predetermined time has elapsed, and thereafter, the isotopic gas that had become selectively adsorbed onto the adsorbing material in the adsorption chamber is taken out from inside the adsorption chamber. Here, since relatively more of the isotopic gas is adsorbed onto the adsorbing material than the first gas, the concentration of the isotopic gas in the mixed gas that is taken out from the adsorption chamber will be higher than the concentration in the mixed gas prior to introduction into the adsorption chamber. And at stage at which the concentration of the isotopic gas has been increased to some degree, the method is switched to distillation to perform further separation and enrichment of the isotopic gas. The isotopic gas is thereby obtained at high purity.

With the present embodiment, ¹²CO is used as the first gas, ¹³CO is used as the isotopic gas to be separated, and zeolite is used as the adsorbing material.

This embodiment shall now be described using the system illustrated in FIG. 1. Helium (He), to be used as carrier gas, is introduced from a piping 101. High-purity carbon monoxide gas (CO), which is the mixed gas, is introduced from a piping 103. Adsorbing material 105 is a zeolite-based adsorbing material, and for example, faujasite zeolite is used. The adsorbing material is housed in an adsorption chamber 107. The interior of adsorption chamber 107 can be adjusted to an arbitrary temperature by means of a temperature regulating device 108. 114 is a recovery tank, which temporarily stores the exhaust from inside adsorption chamber 107. 131 is a distillation column for separating helium, which is the carrier gas, from the carbon monoxide gas. As with the first embodiment, 131 may be a gas separation device, such as a PSA. The function of distillation column 141 is the same as that described with the first embodiment.

Helium is used as the carrier gas for the process of making ¹³CO, which is the isotopic gas, become adsorbed onto adsorbing material 105. Helium is also used as the carrier gas for recovering the isotopic gas ¹³CO that had become adsorbed onto adsorbing material 15. By making helium, which is the carrier gas, flow, the ¹³CO that had become adsorbed onto adsorbing material 105 is desorbed and the ¹³CO is recovered along with the helium.

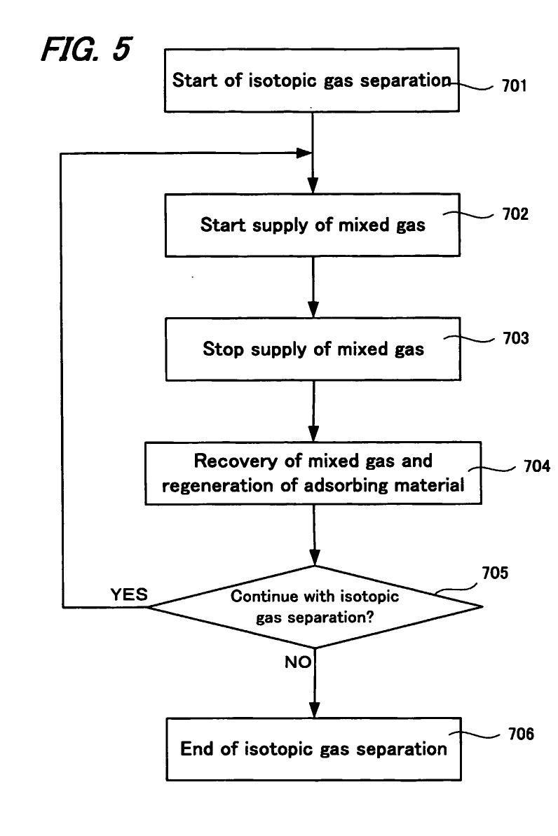

FIG. 5 is a flowchart showing an example of a treatment procedure of an embodiment to which this invention's isotopic gas separation method is applied. First, prior to treatment, an exhaust pump 113 is made to operate with all valves except for a valve 112 being closed to bring the interior of adsorption chamber 107 to a high vacuum state. Valve 112 is then closed and a valve 102 is opened to fill the interior of adsorption chamber 107 with helium gas. This process is repeated several times to remove impurities from the interior of adsorption chamber 107 and heighten the adsorption capacity of adsorbing material 105. Recovery tank 114 is also put in a high vacuum state.

The separation of isotopic gas is started with adsorption chamber 107 being in a high vacuum state (step 701). First, with adsorption chamber 107 being in a high vacuum state, valve 101 and valve 104 are opened. Here, flow regulating devices 400 and 401 are made to operate so that helium and carbon monoxide gas will flow into adsorption chamber 107 at proportions, for example, of 80 volume % and 20 volume %, respectively. The supply of mixed gas is thus started (step 702).

When the pressure inside adsorption chamber 107 reaches atmospheric pressure as a result of the abovementioned supply of helium gas and carbon monoxide gas, valve 112 is opened and while adjusting flow regulating devices 400 and 401 to maintain the pressure inside adsorption chamber 107 at atmospheric pressure, the supply of helium gas and carbon monoxide gas is continued. A state in which helium gas and carbon monoxide gas pass through the interior of adsorption chamber 107 is thus created. The supply of helium gas and carbon monoxide gas is continued, for example, for 200 seconds. The pressure inside adsorption chamber 107 may be maintained at a pressure other than atmospheric pressure.

When carbon monoxide gas is supplied, since ¹³CO is more readily adsorbed by adsorbing material 105, comprising zeolite, than ¹²CO, more of the ¹³CO will become adsorbed to adsorbing material 105. Thus initially, carbon monoxide gas with which the concentration of ¹³CO is low will be exhausted from adsorption chamber 107. When a certain amount of flow has passed through adsorbing material 105, the adsorption equilibrium state is reached and enrichment by selective adsorption of ¹³CO will no longer occur. The ratio of ¹²CO to ¹³CO in the carbon monoxide gas that is exhausted from adsorption chamber 107 will then become the same as that of the stage prior to introduction of the carbon monoxide gas into adsorption chamber 107.

After making helium gas and carbon monoxide gas flow for a predetermined amount of time, valve 102, valve 104, and valve 112 are closed (step 703). Valve 111 is then opened and the gas inside adsorption chamber 107 is recovered by recovery pump 110 into recovery tank 114. In this process, the temperature inside adsorption chamber 107 may be raised, for example, to 423K by means of temperature regulating device 108 to enhance the recovery efficiency. Since adsorption chamber 107 is put in a relatively depressurized state and is heated in this process, the components that had become adsorbed onto adsorbing material 105 become desorbed and are recovered in recovery tank 114 (step 704). With these desorbed components, the value of ¹³CO/¹²CO is greater than that at the state of introduction into adsorption chamber 107. Carrier gas may be made to flow into adsorption chamber 107 in this process to increase the efficiency of recovery.

Next, valve 111 is closed and valve 102 and valve 112 are opened to make helium gas flow into adsorption chamber 107. At this time, the temperature inside adsorption chamber 107 may be raised, for example, at 423K to enhance the regeneration efficiency. Further desorption of the carbon monoxide gas that had become adsorbed onto adsorbing material 105 is thereby carried out to regenerate adsorbing material 105 (step 704). By regeneration, the adsorption performance of adsorbing material 105 is revived. Since the ¹³CO concentration of the exhaust gas from adsorption chamber 105 in this process is higher than the natural concentration, this exhaust gas may also be recovered in recovery tank 114.

The ¹³CO concentration of the recovered carbon monoxide gas is higher than the natural concentration. Carbon monoxide gas, which has thus been enriched in the ¹³CO component, is thus collected in recovery tank 114. The helium gas, which is the carrier gas, is recovered along with the carbon monoxide gas in the recovery tank. Also, without providing recovery tank 114, flow regulating device 118 (or a suitable pump) may be used to intermittently send the carbon monoxide gas, with which the ¹³CO component has been enriched, to distillation column 131.

In the case where separation of the isotopic gas using adsorption is to be continued, a “yes” judgment is made at step 705 and a return to step 702 is performed. In this case, the interior of adsorption chamber 107 is put in a reduced pressure state again and the procedures from step 702 onwards are repeated.

The carbon monoxide gas and helium gas that are stored in recovery tank 114 are sent to distillation column 131 by operation of flow regulating device 118. Separation of helium gas and carbon monoxide gas is carried out at distillation column 131. Since helium gas and carbon monoxide gas differ greatly in boiling point, practically complete separation of helium gas and carbon monoxide gas is carried out at distillation column 131. Here, the carbon monoxide gas, which is the high-boiling-point component, collects at the lower part of distillation column 131 and is sent to distillation column 141 via piping 133. The helium gas, which is the low-boiling-point component, is collected at the upper part of distillation column 131 and is recovered from piping 132.

The carbon monoxide gas that is supplied to distillation column 141 is put in a state where the ¹³CO component has been enriched to at least 10 volume %. In actuality, the above-described ¹³CO separation work using adsorption is carried out in the necessary number of stages until the ¹³CO component is enriched to at least 10 volume %.

The carbon monoxide gas, with which the ¹³CO component has been enriched to at least 10 volume %, is supplied via piping 133 to distillation column 141. Then at distillation column 141, the process of separating ¹³CO, which is the high-boiling-point component, and ¹²CO, which is the low-boiling-point component, is carried out. Since the process at distillation column 141 is the same as that described with the first embodiment, a description thereof shall be omitted.

With the method of the third embodiment, activated carbon, silica gel, or alumina may be used as the adsorbing material. As a zeolite-based adsorbing material, faujasite, pentasil zeolite, mordenite, or A-type zeolite may be used.

### Fourth Embodiment

With this embodiment, an isotopic gas enrichment process by distillation is compared with cases where an isotopic gas enrichment process by distillation is combined with an isotopic gas enrichment process by adsorption in order to explain the advantages of the art by this invention.

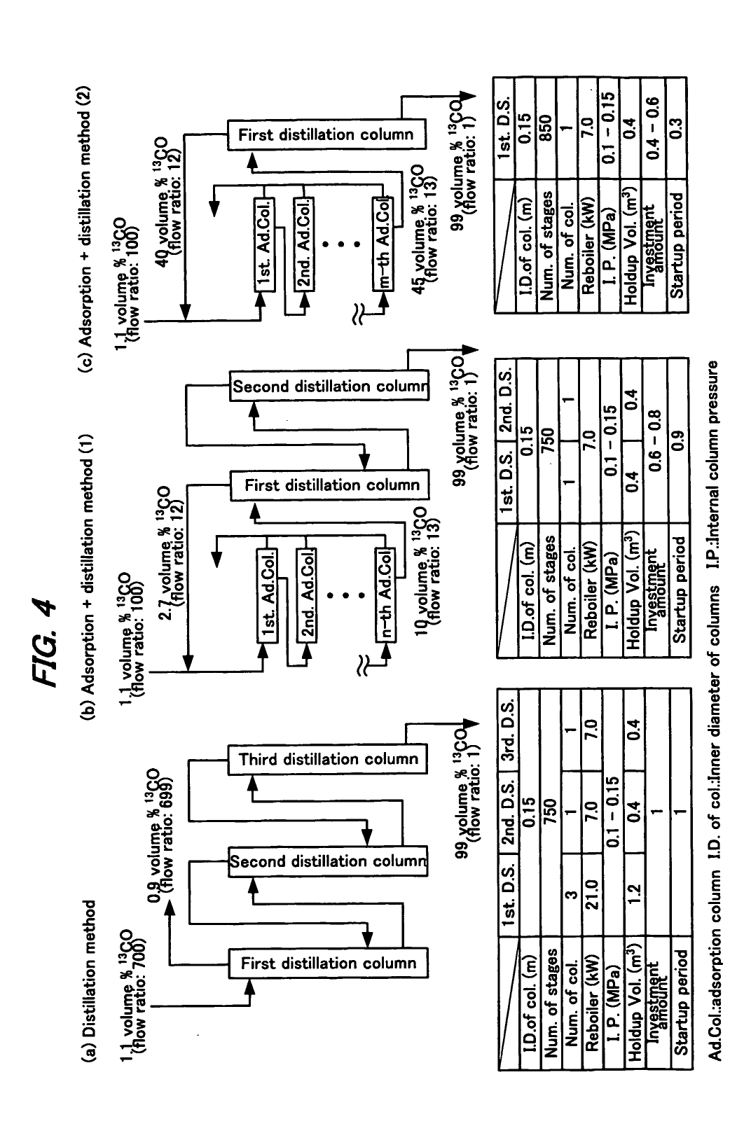

FIG. 4 shows process diagrams for cases of using high-purity carbon monoxide gas, containing ¹³CO at the natural abundance ratio, as the gas to be treated and attempting to obtain ¹³CO of a purity of 99 volume % by (a) distillation, (b) adsorption+distillation (1), and (c) adsorption+distillation (2).

With (a), a five-column arrangement was used in regard to distillation columns, with each distillation column being 0.15 m in inner diameter and having 750 stages. The heat quantity required for the reboilers of the distillation columns was 35 kW for the entirety in this case. Also, the holdup volume, which depends on the number of distillation columns, was 2 m³ in this case.

With (b), the first distillation column of (a) was replaced by an adsorption process, and the method of third embodiment described above was used for this adsorption process. Here, the ¹³CO concentration at the exit of the adsorption process (entrance of the distillation process) was 10 volume %, and a two-column arrangement, with distillation columns of the abovementioned inner diameter and number of stages, was used for the distillation process. The heat quantity required for the reboilers is proportional to the number of distillation columns and was thus reduced to 14 kW and the holdup volume was reduced to 0.8 m³ in comparison to (a).

With (c), the first and second distillation columns of (a) were replaced by an adsorption process, and the method of third embodiment described above was used for this adsorption process. Here, the ¹³CO concentration at the exit of the adsorption process (entrance of the distillation process) was 45 volume %, and a single-column arrangement, with a distillation column of the abovementioned inner diameter and number of stages, was used for the distillation process. The heat quantity required for the reboiler is proportional to the number of distillation columns and was thus reduced to 7 kW and the holdup volume was reduced to 0.4 m³ in comparison to (a).

The above comparison shows that an isotopic gas of a predetermined concentration can be obtained while reducing the heat quantity required for the reboilers and using less energy (heating quantity for heating required at the reboilers and heating quantity for cooling required at the condensers). That is, whereas in the case (a) of using just distillation, three distillation columns were required for the initial stage (first stage) of enrichment and a large consumption energy (for example, consumption power) is required there, by combining with an adsorption process, these three distillation columns can be eliminated. By thus combining an adsorption process at a stage prior to the distillation process, the load on the enrichment process at a stage of lower concentration can be reduced and low consumption energy (for example, power savings) can be achieved.

Also in regard to the period from the start of operation of the equipment to steady-state operation (startup period), since with an adsorption process, an enrichment stage is not required and the startup period can be ignored, the startup period of the entire process depends on the holdup volume of the distillation columns and if the startup period of (a) is set to 1, it is reduced to 0.9 in the case of (b) and to 0.3 in the case of (c). Steady-state operation refers to the operation state at which ¹³CO of predetermined concentration is obtained steadily.

The results of the above described comparison clearly show that the startup period can be reduced by combining an adsorption process at a low enrichment stage (initial stage of the enrichment process). This means that the period from the start of operation of a plant to the shipment of a product can be shortened and gives rise to such economic effects as early recovery of invested capital. The means is thus extremely effective for cases where, for example, an existing plant is to be reinforced to increase the shipment amount in a short period of time.

Also as is clear from FIG. 4, by incorporating an adsorption process at a low enrichment stage (initial stage of the enrichment process in this case), the investment amount necessary for equipment can be reduced. In such a case where carbon monoxide gas is selected as the mixed gas, by performing separation by adsorption until the concentration of ¹³CO gas in the mixed gas becomes 10 volume % and thereafter switching to separation by distillation, the number of distillation columns can be reduced from five to three in comparison to a case where just distillation is performed and the consumption energy can also be reduced greatly accordingly. Furthermore, by performing separation by adsorption until the concentration of ¹³CO gas in the mixed gas becomes 45 volume % and thereafter switching to separation by distillation, further lowering of the consumption energy can be achieved. It can thus be said that for separation of ¹³CO gas using carbon monoxide gas, the use of an adsorption method until the concentration of ¹³CO gas in the mixed gas becomes 10 volume % (or more) is preferable and the use of an adsorption method until the concentration of ¹³CO gas in the mixed gas becomes 45 volume % (or more) is even more preferable.

Though this invention has been described specifically based on embodiments above, this invention is not limited to the above embodiments and may be modified within a scope that does not deviate from the gist of the invention.

With the above-described embodiments of this invention, the separation (enrichment) of the isotopic gas by adsorption may be carried out in several stages or in plurality in parallel. Also, a plurality of separation devices may be prepared to enable the isotopic gas separation process using adsorption to be carried out in plurality in parallel and the treatment timing of the respective separation devices may be shifted suitably so that mixed gas, with which the isotopic gas concentration has been increased, will be supplied continuously to the isotopic separation process using distillation.

1. An isotopic gas separation method for separating, from a mixed gas containing a molecular or atomic first gas, an isotopic gas of said first gas, comprising: one of either a first treatment procedure, in turn comprising the steps of:
supplying said mixed gas to a gas inlet of an adsorption chamber; and taking out the isotopic gas of said first gas that flows out from a gas outlet of said adsorption chamber from the start of supplying of said mixed gas to the point of elapse of a predetermined time; or
a second treatment procedure, in turn comprising: a first step of sealing said mixed gas in an adsorption chamber; a second step of making said mixed gas flow out from said adsorption chamber after said first step;
and a third step of taking out the isotopic gas of said first gas after the elapse of a predetermined time from the start of said second step; and
further comprising: a treatment procedure of enriching, by distillation, the isotopic gas of said first gas that has been taken out.

2. The isotopic gas separation method as set forth in claim 1, wherein a porous material is set as a material for adsorbing said isotopic gas in said adsorption chamber.

3. The isotopic gas separation method as set forth in claim 2, wherein said porous material is activated carbon, zeolite, or a complex.

4. The isotopic gas separation method as set forth in claim 1, wherein said mixed gas is methane gas or ammonia gas.

5. The isotopic gas separation method as set forth in claim 1, wherein the concentration of said isotopic gas is increased at least to a concentration exceeding the natural abundance ratio through said first treatment procedure or second treatment procedure.

6. An isotopic gas separation method for separating, from a mixed gas containing a molecular or atomic first gas, an isotopic gas of said first gas, comprising the steps of:
supplying said mixed gas to a gas inlet of an adsorption chamber;
stopping said supply after the elapse of a predetermined time from the start of supply of said mixed gas;
relatively depressurizing the interior of said adsorption chamber and taking out said mixed gas that had become adsorbed inside said adsorption chamber; and
enriching, by distillation, the isotopic gas of said first gas contained in said mixed gas that has been taken out.

7. The isotopic gas separation method as set forth in claim 6, wherein a porous material is set as a material for adsorbing said isotopic gas in said adsorption chamber.

8. The isotopic gas separation method as set forth in claim 7, wherein said porous material is zeolite, activated carbon, silica gel, or alumina.

9. The isotopic gas separation method as set forth in claim 6, wherein said mixed gas is carbon monoxide gas.

10. The isotopic gas separation method as set forth in claim 6, wherein, in a stage prior to said step of enriching by distillation, the concentration of said isotopic gas is at least a concentration exceeding the natural abundance ratio.

11. An isotopic gas separation method for separating, from a mixed gas containing a molecular or atomic first gas, an isotopic gas of said first gas, comprising the steps of:
supplying said mixed gas to a gas inlet of an adsorption chamber;
stopping said supply after the elapse of a predetermined time from the start of supply of said mixed gas;
making a carrier gas flow inside said adsorption chamber and taking out, along with said carrier gas, said mixed gas that had become adsorbed inside said adsorption chamber; and
enriching, by distillation, the isotopic gas of said first gas contained in said mixed gas that has been taken out.

12. The isotopic gas separation method as set forth in claim 11, wherein a porous material is set as a material for adsorbing said isotopic gas in said adsorption chamber.

13. The isotopic gas separation method as set forth in claim 12, wherein said porous material is zeolite, activated carbon, silica gel, or alumina.

14. The isotopic gas separation method as set forth in claim 11, wherein said mixed gas is carbon monoxide gas.

15. The isotopic gas separation method as set forth in claim 11, wherein, in a stage prior to said step of enriching by distillation, the concentration of said isotopic gas is at least a concentration exceeding the natural abundance ratio.

16. An isotopic gas separation device for separating, from a mixed gas containing a molecular or atomic first gas, an isotopic gas of said first gas, comprising:
an adsorption chamber, the interior of which can be set to a depressurized state of a pressure lower than atmospheric pressure;
a gas exhausting means, exhausting gas from said adsorption chamber;
a gas supply port, supplying gas into said adsorption chamber, and a gas discharge port, discharging gas out from said adsorption chamber, or a gas supply/discharge port, supplying and discharging gas to and from said adsorption chamber;
a single or a plurality of valves or a gas flow controlling means, controlling the supply, discharge, sealing, or supply flow rate of gas with respect to said adsorption chamber or controlling the gas pressure inside said adsorption chamber;
a porous material, set inside said adsorption chamber, as a material for adsorbing said isotopic gas; and
a distillation device, disposed at a stage subsequent said gas discharge port or gas supply/discharge port and distilling the discharged gas taken out from said gas discharge port or gas supply/discharge port.

17. The isotopic gas separation device as set forth in claim 16, wherein said mixed gas is methane gas, ammonia gas, or carbon monoxide gas.

18. The isotopic gas separation device as set forth in claim 16, wherein said porous material is activated carbon, zeolite, a complex, silica gel, or alumina.

19. The isotopic gas separation device as set forth in claim 16, further comprising a means for heating said adsorbing material inside said adsorption chamber.

20. An isotopic gas separation method for separating, from a mixed gas containing a molecular or atomic first gas, an isotopic gas of said first gas, comprising the steps of:
making said mixed gas contact an adsorbing material with selectivity in the adsorption of said first gas and said isotopic gas and obtaining a mixed gas with which said isotopic gas is enriched; and
enriching the concentration of said isotopic gas further by distillation.

21. An isotopic gas separation device for separating, from a mixed gas containing a molecular or atomic first gas, an isotopic gas of said first gas, comprising:
an adsorption chamber, in which said mixed gas is made to flow or is sealed and having installed therein an adsorbing material with selectivity in the adsorption of said first gas and said isotopic gas; and
a distillation device, distilling the discharged gas taken out from said adsorption chamber.
